(19) United States
(12) Patent Application Publication
(10) Pub. No.: US 2005/0125845 A1
(43) Pub. Date: Jun. 9, 2005

(54) Set-top software mechanism for insertion of a unique non-intrusive digital signature into video program content

(76) Inventors: Charles R. Hardt, Lawrenceville, GA (US); Cesar A. Moreno, Lawrenceville, GA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/730,551

(22) Filed: Dec. 8, 2003

(51) Int. Cl. H04N 7/16; H04N 7/08; H04N 11/00; H04N 7/00

(52) U.S. Cl. 725/137; 348/468; 348/461; 725/136

(57) ABSTRACT

A method (40, 50) and apparatus (30) for processing a video signal inserts a unique digital signature into the video signal. Thus, rampant duplication or distribution can be traced back to a particular set-top box or receiver. According to one aspect of the present invention, the unique digital signal is inserted into the vertical blanking interval. An apparatus (30) for processing a video signal includes a processor (31) receiving the video signal and outputting a modified video signal having a vertical blanking interval, which includes a digital signature uniquely identifying the processor (31). A memory (33) stores the digital signature and a teletext generator (32) coupled to the memory (33) and the processor (31) and generates a teletext signal that includes the digital signature for insertion into the vertical blanking interval by the processor (31) prior to the processor (31) outputting the video signal.

### FIELD OF THE INVENTION

The present invention is directed generally to methods and apparatuses for processing video signals at user premises, and more particularly to a method and apparatus for processing a video signal at a user premise, in which the video signal originates at a broadcast location.

### BACKGROUND

A consumer with a PVR enabled set-top can create multiple analog copies of a previously recorded digital event. The connection between a digital set-top and that of a standard VCR is in analog format, thus any duplicated event will suffer some form of quality degradation. However, this loss will not be perceivable to all consumers. Thus it is possible for one consumer to make and distribute multiple copies of an event. It is furthermore possible that one consumer could legitimately receive a broadcast, decode it, and then distribute the analog content to multiple illegitimate consumers.

Methods exist that attempt to prevent illegitimate copying of video signals, however, these methods usually prevent or impose burdens on legitimate copying as well.

The present invention is therefore directed to the problem of developing a method and apparatus for reducing illegitimate duplication of a broadcast video signal without burdening or preventing legitimate duplication.

### SUMMARY OF THE INVENTION

The present invention solves these and other problems by providing inter alia a method and apparatus for inserting a unique digital signature into a video signal. Thus, rampant duplication or distribution can be traced back to a particular set-top box, receiver or decoder.

According to one aspect of the present invention, the unique digital signal is inserted into the vertical blanking interval. This may be accomplished when the video signal is in analog form or in digital form. In the latter case, bits representing the digital signature are delivered to a digital video processor, which inserts the bits into the appropriate place in the digital signal so that when the digital signal is converted to an analog form, the bits appear in the vertical blanking interval of the analog video signal.

Other aspects of the present invention will be apparent to those reviewing the following drawings in light of the specification.

### BRIEF DESCRIPTION OF THE DRAWINGS

FIG. 1 depicts a sample of a video image that includes a digital signature placed in the vertical blanking interval when the digital signature is not apparent to the viewer according to a first aspect of the present invention.

FIG. 2 depicts the sample of the video image of FIG. 1 with the digital signature activated according to a first aspect of the present invention.

FIG. 3 depicts an exemplary embodiment of an apparatus for inserting a digital signature into a vertical blanking interval of a video signal according to another aspect of the present invention.

FIG. 4 depicts an exemplary embodiment of a method for inserting a digital signature into a video signal according to yet another aspect of the present invention.

FIG. 5 depicts another exemplary embodiment of a method for inserting a digital signature into a video signal according to still another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

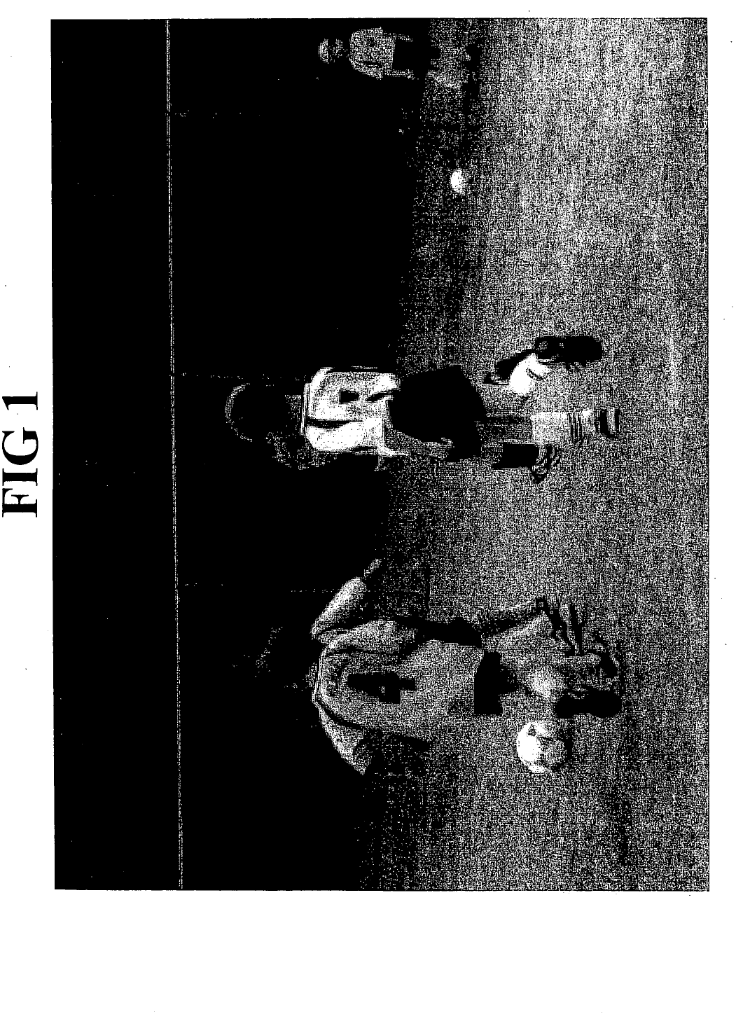

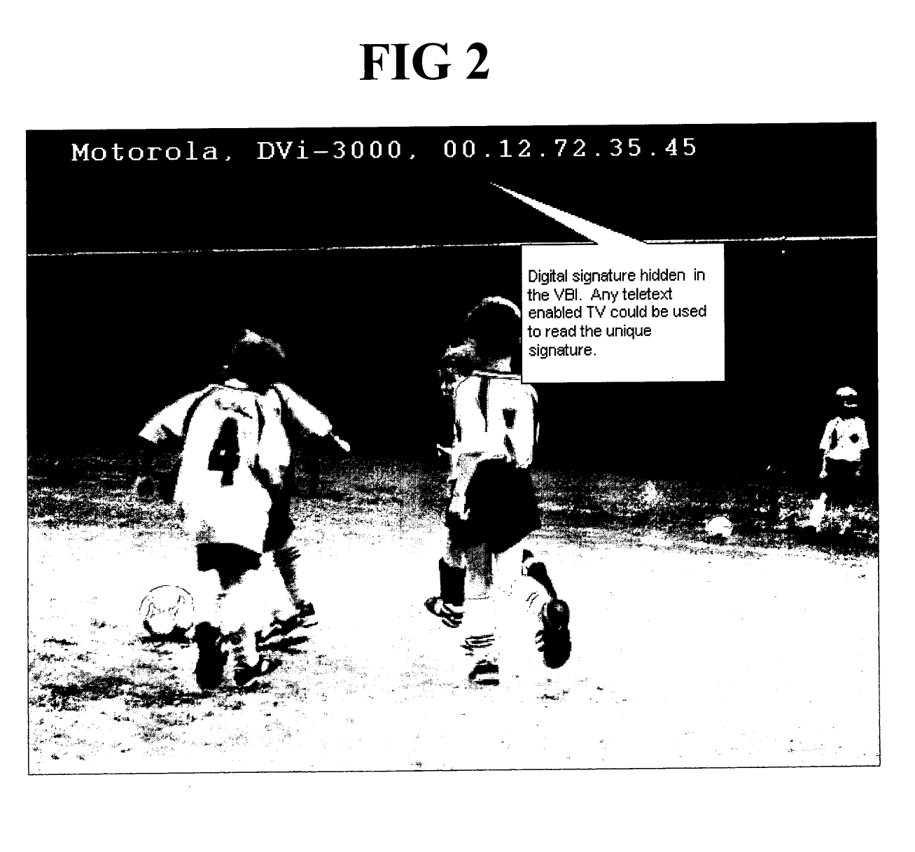

According to one aspect of the present invention, to help track (and thus help prevent) rampant illegal content distribution in various parts of the world, the set-top software inserts a unique digital signature (e.g., possibly the set-top's unit address, or a unique serial number that is loaded into the set-top in the factory and cannot be modified by the user.) into the vertical blanking interval (VBI) using the set-top box's teletext generation hardware. This signature data can then be transmitted to a VCR or TV via standard teletext messages in the VBI. There are 899 possible teletext pages. The set-top software would transmit the unique signature on one these pages. Any Teletext ready TV can then be used to view the signature. This would be a non-intrusive message, thus the contents of the message would not normally be visible to the consumer, as shown in FIGS. 1 and 2.

The purpose of the embodiments herein is to provide a method to track illegal content distribution in various parts of the world. By transmitting a unique digital signature in the VBI, any Teletext ready TV can be used to view the unique set-top signature. Thus, if one set-top was being used to create illegal video taped copies of an event, each and every copy would contain the digital signature of the set-top that was used to create the tape. Generally speaking this signature would be hidden from the consumer watching the recorded event. The signature would only be visible to the consumer/investigator when the TV was requested to decode a predefined teletext page. This same method could also be used to track or counter the individual who acts as an independent (illegal) apartment building or neighborhood MSO (one decoder driving multiple 100s of TVs).

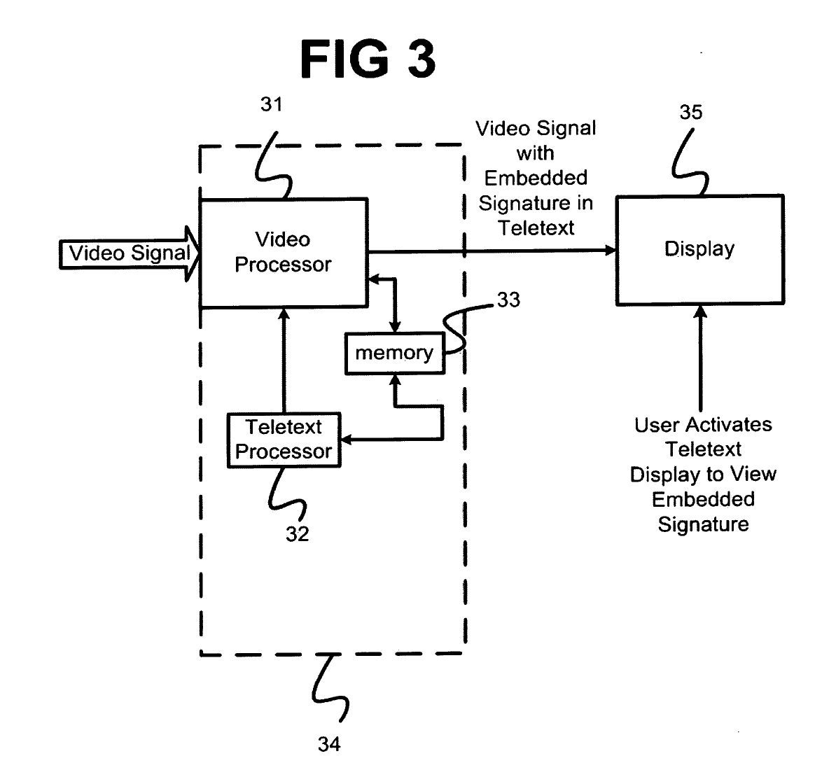

FIG. 3 shows a block diagram of an apparatus for inserting a unique signature into a video signal. The video signal enters the decoder/receiver/set-top box 34 and is then processed in the normal manner by a video processor 31. The video signal can arrive from any of a variety of sources, such as digital broadcast television from either satellite or terrestrial sources; analog broadcast television from either satellite or terrestrial sources; a video playback device, such as a VCR, VTR, DVD or CD-ROM; and a camera, in which case the digital signature will also identify the originator of the video.

The video processor 31 can be a standard analog or digital receiver, an audio/video receiver that processes the video in digital or analog forms, or a video decoder that converts an incoming digital video signal into its constituent video signals, one or more of which can be selected for subsequent display or other processing.

A standard teletext processor 32 (or teletext function within a video processor) forwards a digital signature that is stored in memory 33, which is accessible either to the video processor 31 or the teletext processor 32 (or teletext function within the video processor) to the video processor 32 for insertion into the teletext portion of the video, e.g., the vertical blanking interval in an analog video signal. The video with the embedded digital signature is then output for display to the user's display device 35. The teletext processor 32 generates teletext data for insertion into the vertical blanking interval of the video signal. If the video processor is processing the video in digital form, the teletext processor generates a digital bit stream that is inserted into the proper place in the digital bit stream so that the teletext generated bit stream appears in the vertical blanking interval of the analog signal. These locations are typically defined in the various MPEG standards and are known to those of skill in the art.

A display device 35, such as a television or monitor, typically has the capability to display the information included in the teletext subchannel carried in the vertical blanking interval of the analog signal. The display device 35 will typically overwrite the video image being displayed with the contents of the teletext subchannel, often at the bottom of the screen. This enables any subsequent recipient of the video signal to view the embedded digital signature.

To view the digital signature, the user can simply activate the teletext display function in the normal manner, such as entering the configuration setup using the remote control for the display device 35. Thus, all video that enters the decoder/receiver/set-top box is altered to have the digital signature embedded in it to uniquely identify the decoder/receiver/set-top box. Moreover, further processing of such a video signal would result in multiple digital signatures being embedded in the signal. Thus, the creator of a video signal could employ this technique to “sign” his or her video signal to indicate the authorship or authenticity of the video signal.

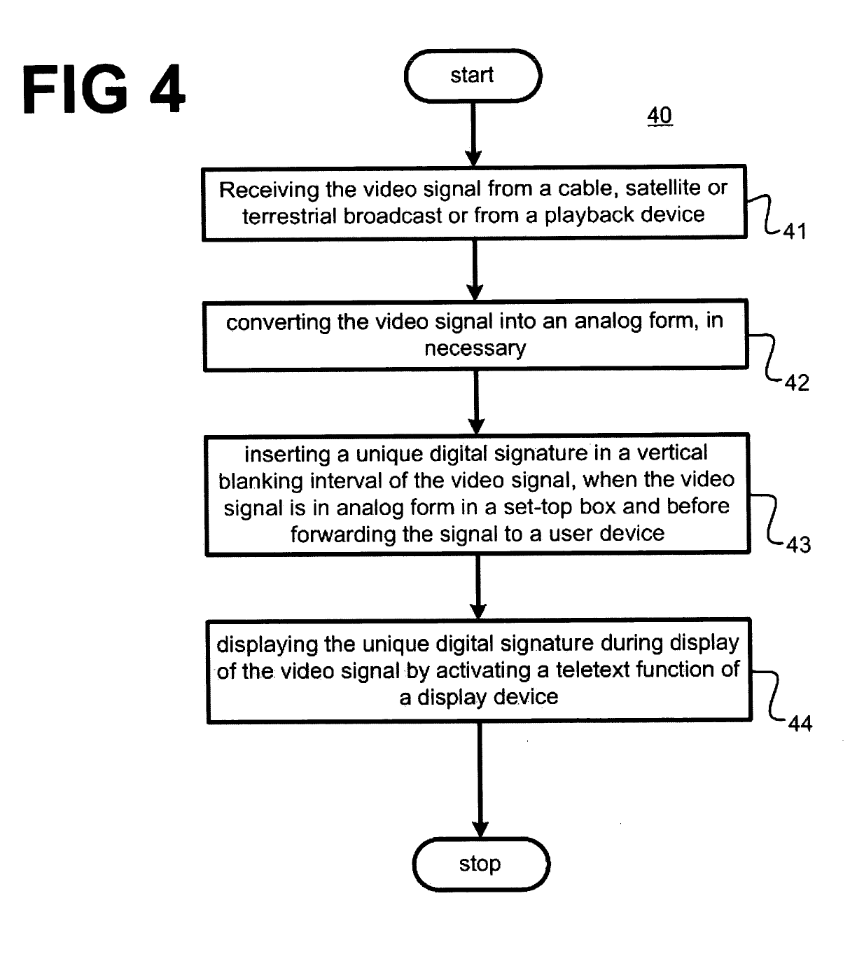

Turning to FIG. 4, shown therein is an exemplary embodiment of a method for processing a video signal.

In step 41, the video signal is received from a cable, satellite or terrestrial broadcast or from a playback device. The video signal can also be received from a video generation device, such as a camera or computer.

In step 42, the video signal is converted into an analog form, if necessary.

In step 43, a unique digital signature is inserted in a vertical blanking interval of the video signal, when the video signal is in analog form in a set-top box and before forwarding the signal to a user device. This unique digital signature can be a series of digits (e.g., a serial number) that uniquely identifies the receiver or set-top box. Alternatively, the unique digital signature can be some other address associated with the set-top box or receiver.

In step 44, the unique digital signature is displayed during display of the video signal by activating a teletext function of a display device.

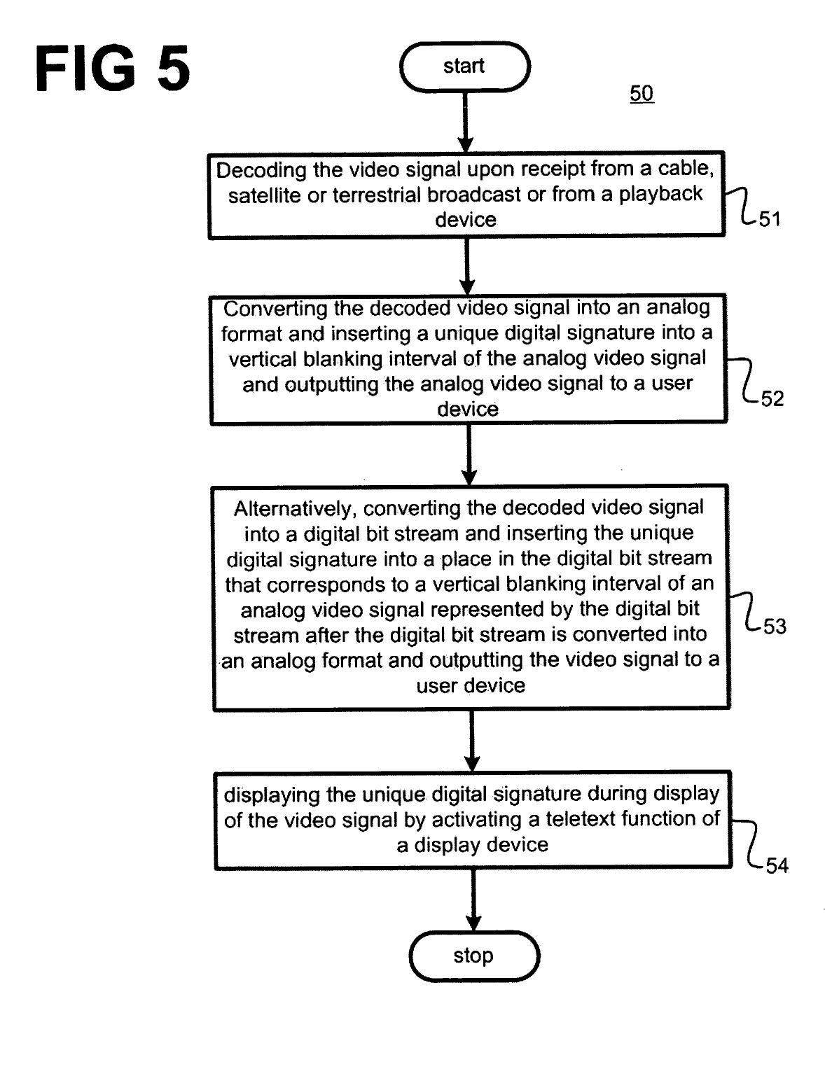

FIG. 5 shows an exemplary embodiment of another method for processing video signals.

In step 51, the video signal is decoded upon receipt from a cable, satellite or terrestrial broadcast or from a playback device. In some cases, this can refer to separating the incoming wideband signal into a single video signal or converting the received digital signal to a bit stream.

In step 52, the decoded video signal is converted into an analog format and a unique digital signature is inserted into a vertical blanking interval of the analog video signal and the analog video signal is then output to a user device.

In step 53, alternatively, the decoded video signal is converted into a digital bit stream and the unique digital signature is inserted into a place in the digital bit stream that corresponds to a vertical blanking interval of an analog video signal represented by the digital bit stream after the digital bit stream is converted into an analog format and the resulting video signal is output to a user device. In this case, the video signal being output can be analog or digital.

In step 54, the unique digital signature can be displayed during display of the video signal by activating a teletext function of a display device.

The embodiments herein are applicable to Motorola product numbers DVi-5000, DVi-4000, DVi-3000, DVi-1000, & DVi-700.

Although various embodiments are specifically illustrated and described herein, it will be appreciated that modifications and variations of the invention are covered by the above teachings and are within the purview of the appended claims without departing from the spirit and intended scope of the invention. While the embodiments herein depict the insertion of a unique digital signature into the vertical blanking interval of a video signal, the digital signature could also be placed into any appropriate location for a digital television signal without departing from the present invention. Moreover, any signature could be employed as the identifier. Furthermore, these examples should not be interpreted to limit the modifications and variations of the invention covered by the claims but are merely illustrative of possible variations.

1. A method (40) for processing a video signal at a user premises comprising:
receiving (41) the video signal; and
inserting (43) a unique digital signature in a vertical blanking interval of the video signal.

2. The method (40) according to claim 1, further comprising:
inserting (42) the unique digital signature into the vertical blanking interval of the video signal when the video signal is in analog form.

3. The method (40) according to claim 1, further comprising:
inserting (42) the unique digital signature into the vertical blanking interval of the video signal before forwarding the video signal to any user equipment.

4. The method (40) according to claim 1, further comprising:
inserting (42) the unique digital signature into the vertical blanking interval of the video signal in a set-top box.

5. The method (40) according to claim 1, further comprising:
converting (43) the video signal into an analog form before inserting the unique digital signature into the vertical blanking interval of the video signal.

6. The method (40) according to claim 1, wherein the unique digital signature identifies a receiver that receives the video signal.

7. The method (40) according to claim 1, wherein the unique digital signature identifies a set-top box that receives the video signal.

8. The method (40) according to claim 1, wherein the unique digital signature includes a uniform resource locator.

9. The method (40) according to claim 1, further comprising:
displaying (44) the unique digital signature during display of the video signal by activating a teletext function of a display device.

10. A method (50) for processing a video signal comprising:
decoding (51) the video signal upon receipt;
inserting (52) a unique digital signature in a vertical blanking interval of the video signal.

11. The method (50) according to claim 10, wherein the unique digital signature identifies a decoder that receives the video signal.

12. The method (50) according to claim 10, further comprising:
converting (52) the decoded video signal into an analog format.

13. The method (50) according to claim 10, further comprising:
converting (53) the decoded video signal into a digital bit stream and inserting the unique digital signature into a place in the digital bit stream that corresponds to a vertical blanking interval of an analog video signal represented by the digital bit stream after the digital bit stream is converted into an analog format.

14. A method (50) for processing video at a user premises comprising:
decoding (51) a received digital video signal into a digital bit stream; and
inserting (53) a unique digital signature into a place in the digital bit stream that corresponds to a vertical blanking interval of an analog video signal represented by the digital bit stream after the digital bit stream is converted into an analog format.

15. The method (50) according to claim 14, further comprising:
converting (52) the digital bit stream into an analog video signal and outputting the analog video signal to a user device.

16. The method (50) according to claim 15, further comprising:
activating (54) a display of the unique digital signature during display of the video signal by activating a teletext function of a display device.

17. An apparatus (30) for processing a video signal comprising:
a processor (31) receiving the video signal and outputting a modified video signal having a vertical blanking interval, which includes a digital signature uniquely identifying the processor (31);
a memory (33) storing the digital signature; and
a teletext generator (32) coupled to the memory (33) and the processor (31) and generating a teletext signal that includes the digital signature for insertion into the vertical blanking interval by the processor (31) prior to the processor (31) outputting the video signal.

18. The apparatus (30) according to claim 17, wherein the processor (31):
inserts the unique digital signature into the vertical blanking interval of the video signal when the video signal is in analog form.

19. The apparatus (30) according to claim 17, wherein the processor (31):
converts the video signal into an analog form before inserting the unique digital signature into the vertical blanking interval of the video signal.

20. The apparatus (30) according to claim 17, wherein the processor (31):
converts the video signal into a digital bit stream and inserts the unique digital signature into a place in the digital bit stream that corresponds to a vertical blanking interval of an analog video signal represented by the digital bit stream after the digital bit stream is converted into an analog format.
